(19) United States
(12) Patent Application Publication
(10) Pub. No.: US 2005/0135634 A1
(43) Pub. Date: Jun. 23, 2005

(54) Wireless transmission device of surround sound stereo system

(75) Inventor: Chen-Tong Wu, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: Eastern Asia Technology Limited

(21) Appl. No.: 10/740,637

(22) Filed: Dec. 22, 2003

(51) Int. Cl. H04B 5/00; H04R 5/00

(52) U.S. Cl. 381/79; 381/1

(57) ABSTRACT

The present invention discloses a wireless transmission device for surround sound stereo systems using a front mixer to mix the subwoofer signal of the main stereo system with the left and right surround signals into a 2-channel signal and transmit the signal by a radio frequency. After the subwoofer receives and decodes the signal, and the rear crossover separates the subwoofer signal and sends the subwoofer signal, left surround signal, and right surround signal respectively to the corresponding speakers for the playback, such arrangement provides a wireless signal transmission between the subwoofer and the main stereo system.

### FIELD OF THE INVENTION

The present invention relates to a wireless transmission between a subwoofer speaker, a left surround speaker, a right surround speaker, and a stereo system.

### BACKGROUND OF THE INVENTION

In general, a surround sound stereo system usually installs a front left speaker, a front right speaker, and a center speaker in the front, a surround left speaker and a surround right speaker at the back, and a subwoofer at an appropriate position of the environment to achieve the so-called 6-channel (or 5.1-channel) surround sound effect.

The traditional way of setting up a surround sound stereo system generally uses cables for the signal transmission between each speaker and the main stereo system, and the main stereo system is usually installed in the front of the audience. Therefore, the cables of the front left speaker, front right speaker, and center speaker will not be in the way of audience's movement path, but the cables between the surround left speaker, surround right speaker, and the main stereo system may have to cross the audience's movement path and thus becoming an obstacle to the audiences. More seriously, the cable may be pulled by accident and topple or damage the stereo system.

Therefore, a wireless stereo system as shown in FIG. 1 was introduced to the market, and such wireless stereo system used a wireless transmission technology to transmit signals between left and right surround speakers 23, 24 and the stereo system 10 in order to leave out the cable installation between the left and right surround speakers 23, 24 and the stereo system 10. The front left and front right speakers 21, 22, center speaker 26, and subwoofer 25 still use a cable 30 to transmit signals with the main stereo system 10. However, the whole set of equipment requires to install a signal transmitter (not shown in the figure) in the main stereo system 10 and a signal receiver 40 in each of the left surround speaker and right sound speaker 23, 24, which will greatly increase the cost of the whole stereo system. In addition, the volume of the left and right surround speakers 23, 24 will become bulky after the signal receiver 40 is installed.

In FIG. 2, a signal receiver 40 is installed in the right surround sound 24, and a cable 30 is used to transmit signals for the left and right surround speakers 23, 24. Such stereo system can leave out the installation of signal receivers, and thus lowering the cost of the whole stereo system. However, the stereo system of this kind has the shortcoming of having different sized left and right surround speakers 23, 24.

Please refer to FIG. 3 for a stereo system which installs an additional independent signal receiver 40 and uses a cable 30 for the signal transmission between the left and right surround speakers 23, 24 in order to solve the problem of the different sized left and right surround speakers 23, 24. However, such arrangement not only adds components to the system, but also keeps using a cable 30 for the signal transmission between the subwoofer 25 and the stereo system 10. Therefore, the cable 30 is still in the way of the audience's movement path.

### SUMMARY OF THE INVENTION

The primary objective of the present invention is to provide a wireless transmission device for the surround sound stereo system by using a front mixer to mix the subwoofer signal of the main stereo system with the left and right surround signals into a 2-channel signal and transmit the signal by a radio frequency. After the subwoofer receives and decodes the signal, and the rear crossover separates the subwoofer signal and sends the subwoofer signal, left surround signal, and right surround signal respectively to the corresponding speakers for the playback, such arrangement provides a wireless signal transmission between the subwoofer and the main stereo system and also allows the signal transmission for the subwoofer and left surround speaker with the main stereo system without using a cable.

### BRIEF DESCRIPTION OF THE DRAWINGS

FIG. 1 is an illustrative diagram of installing a conventional surround sound stereo system.

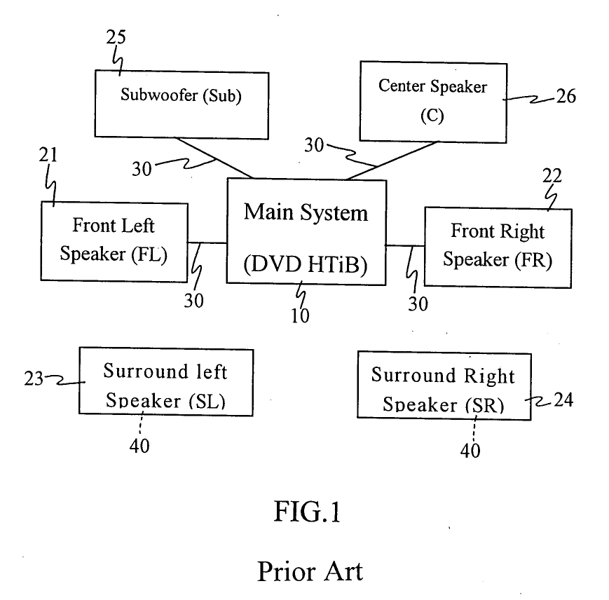

FIG. 2 is an illustrative diagram of installing a main stereo system and surround speakers using a prior-art wireless transmission method.

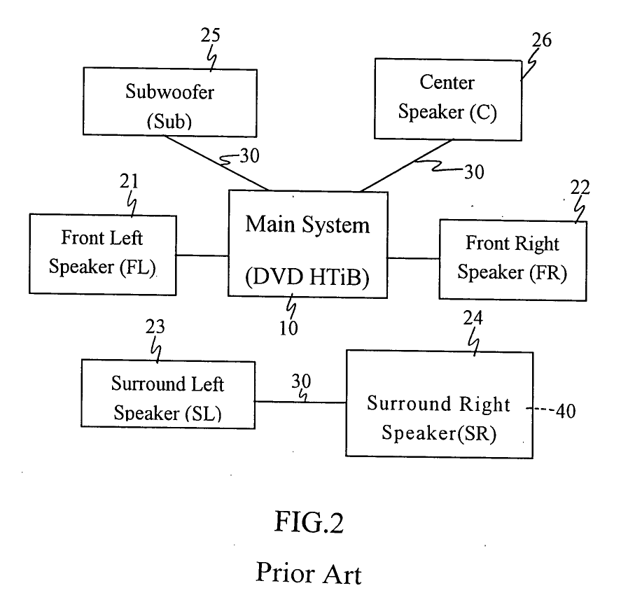

FIG. 3 is an illustrative diagram of installing a main stereo system and surround speakers using another prior-art wireless transmission method.

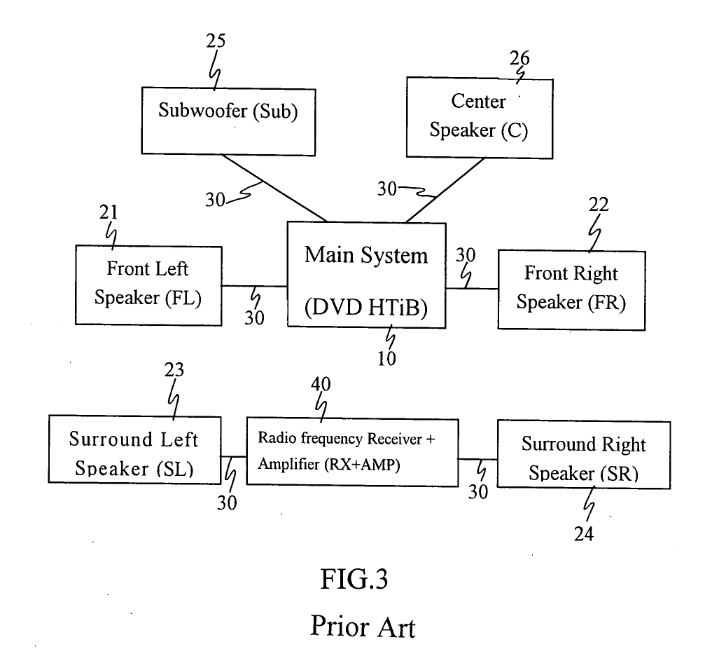

FIG. 4 is an illustrative diagram of the structures of the front low-pass filter, front high-pass filter, front mixer, radio frequency transmitting module, and front power supply circuit of the present invention.

FIG. 5 is an illustrative diagram of the structures of the rear mixer, radio frequency receiving module, rear low-pass filter, rear high-pass filter, and rear power supply circuit of the present invention.

FIG. 6 is an illustrative diagram of installing the speakers and main stereo system of the present invention.

FIG. 7 is an illustrative diagram of installing the speakers and main stereo system according to another preferred embodiment of the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

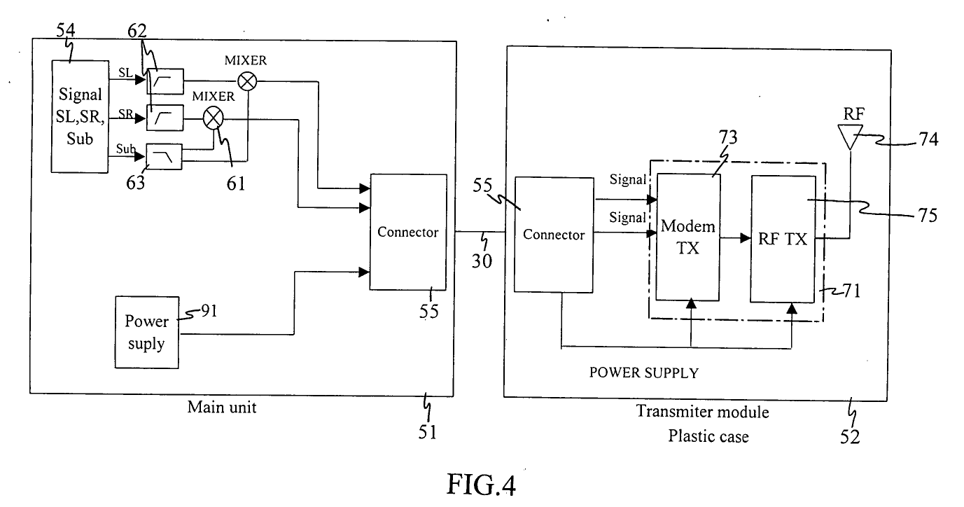

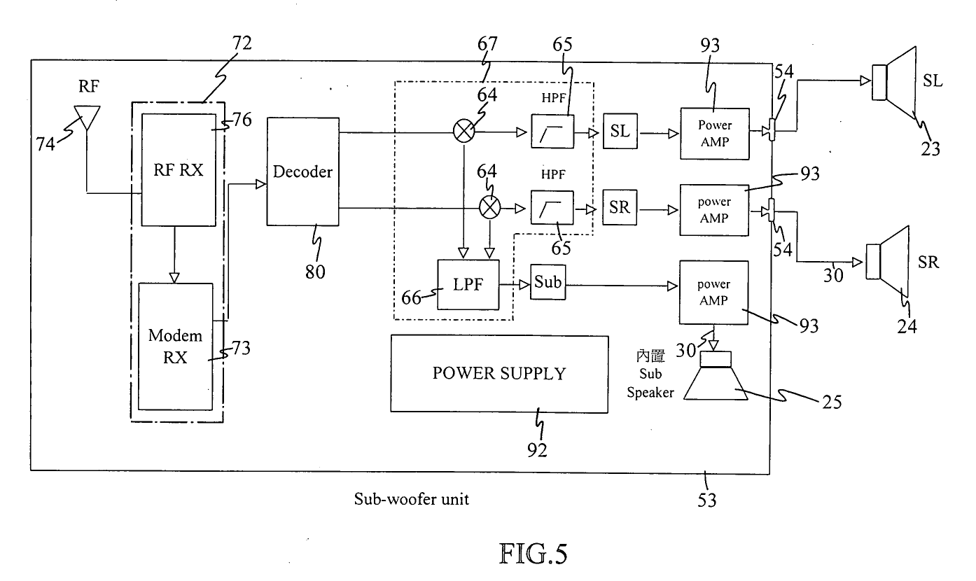

Please refer to FIGS. 4 and 5 for the wireless transmission device of surround sound stereo system of this invention. The basic structure of the whole wireless transmission device comprises:
at least one front mixer 61, for mixing the subwoofer signal outputted from the main stereo system into the left and right surround signals; wherein the left and right surround signals outputted from the main stereo system after being processed by the front high-pass filter 62 enter the front mixer 61, and the subwoofer signal outputted from the main stereo system after being processed by the front low-pass filter 63 enters the front fixer 61;
a radio frequency transmitting module 71, comprising a modem 73, a radio frequency transmitter 75, and an antenna 74 and receiving the 2-channel signal produced by mixing the subwoofer signal of the main stereo system and the left and right surround signals through a cable 30, and transmitting the 2-channel signal by a radio frequency, and having a front power supply circuit 81 for driving the operation of the radio frequency transmitting module 71;
a radio frequency receiving module 72, comprising a modem 73, a radio frequency receiver 76, and an antenna 74, for receiving the signal transmitted from the radio frequency transmitting module 71;
a decoder 80, coupled to the radio frequency receiving module 72, for decoding the signal received by the radio frequency receiving module 71, and having a rear power supply circuit 92 for driving the operation of the radio frequency receiving module 72;
at least one rear crossover 67, comprising a rear distributor 64, a rear high-pass filter 65, and a rear low-pass filter and all of these components being disposed at the rear section of the decoder 80 for separating the subwoofer signal from the left and right surround signals and outputting the subwoofer signal, left surround signal, and right surround signal to the corresponding speakers for the playback; wherein the left and right surround signals separated from the rear distributor 64 are recovered by the high-pass filter 65 and outputted to the left and right surround sound speakers 23, 24 via the amplify circuit 93, and the subwoofer signal separated by the rear distributor 64 is recovered by the rear low-pass filter 66 and outputted to the subwoofer 25 via the amplify circuit 93.

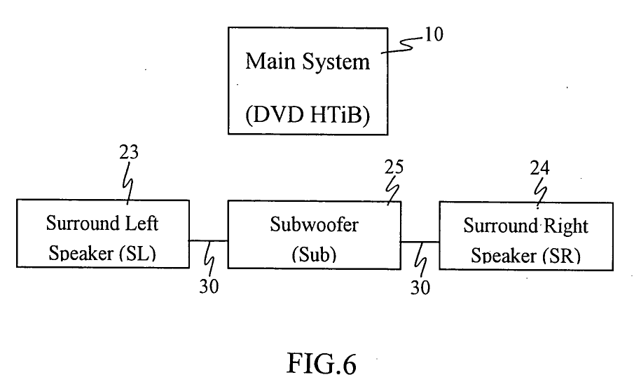

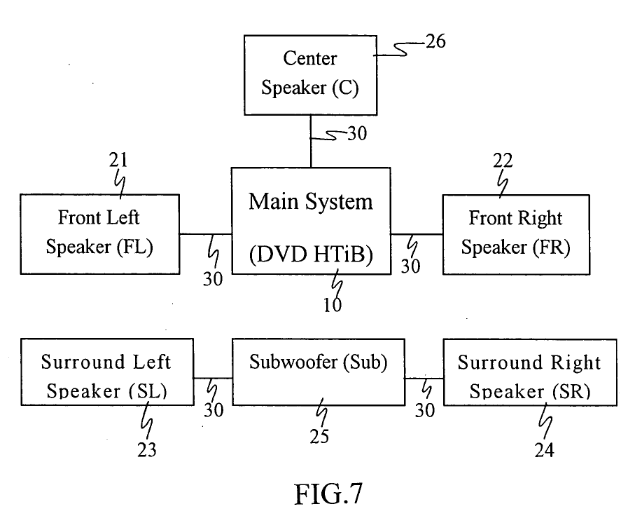

The foregoing components constitute a wireless transmission device as shown in FIGS. 5 for outputting the subwoofer signal, left surround signal, and right surround signal of the main stereo system 10, particularly integrating the rear distributor 64, radio frequency receiving module 72, rear high-pass filter 65, rear low-pass filter 66, amplify circuits 83, rear power supply circuit 92, and subwoofer 25 into a housing 53 and providing a port 54 and a cable 30 for connecting the left and right surround speakers 23, 24. The actual installation of the whole set of stereo system 10 as shown in FIG. 6 can provide the wireless transmission of signals between the subwoofer 25 and the main stereo system 10, and allow signal transmission between the left and right surround speakers 23, 24 and the main stereo system 10 without using a cable 30. Of course, the whole main stereo system 10 also can use a cable 30 to connect the front left and right speakers 21, 22 and the center speaker 26 as shown in FIG. 7 for the application.

In addition, the front mixer 61 and radio transmitting module 71 of this invention can be installed inside the main stereo system 10 and the operation of the radio frequency transmitting module 71 is driven directly by the power supply circuit of the main stereo system 10. Alternatively, the front high-pass filter 62, front low-pass filter 63, and front mixer 61 are integrated into the housing 51 as shown in FIG. 4, and a port 54 is set for connecting the circuit of the main stereo system 10. The radio frequency transmitting module 71 is installed in another housing 51 and a connector 55 is installed for the signal connection and power supply. Such arrangement can separate the radio frequency transmitting module 71 with the main stereo system 10 and place the radio frequency transmitting module 71 at a better transmitting position.

Of course, the subwoofer signal can be selectively mixed into the left surround signal or the right surround signal or both to enhance the subwoofer performance.

In summation of the above description, the present invention discloses a better and operable wireless transmission mode for the surround sound stereo system and enhances the performance of the conventional structure, and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A wireless transmission device of surround sound stereo system, comprising:
at least one front mixer, for mixing a subwoofer signal with left and right surround signals outputted from a stereo system;
a radio frequency transmitting module, comprising a modem, a radio frequency transmitter, and an antenna, and using a cable to receive a two-channel signal produced by mixing said subwoofer signal and said left and right surround signals of said stereo system and transmit said two-channel signal by a radio frequency;
a front power supply circuit, for driving the operation of said radio frequency transmitting module;
a radio frequency receiving module, comprising a modem, a radio receiver, and an antenna, for receiving the signal transmitted from said radio frequency transmitting module;
a decoder, coupled to said radio frequency receiving module for decoding the signal received by said radio frequency receiving module:
at least one rear crossover, having at least one selected from the collection of a rear distributor, a rear high-pass filter, and a rear low-pass filter and being disposed at the rear section of said decoder, for separating said subwoofer signal from said left and right surround signals to facilitate the output of subwoofer signal, left surround signal and right surround signal to the corresponding speakers by a cable;
a rear power supply circuit, for driving the operation of said radio frequency receiving module;
thereby constituting a wireless transmission device for outputting the subwoofer signal, left and right surround signals of said main stereo system.

2. The wireless transmission device of surround sound stereo system of claim 1, wherein said front mixer and radio frequency transmitting module are disposed inside said main stereo system, and said front power supply circuit is electrically coupled with the power supply circuit of said main stereo system.

3. The wireless transmission device of surround sound stereo system of claim 1, wherein said rear crossover, radio frequency receiving module, rear power supply circuit, and subwoofer are integrated in a housing, and have a port for electrically connecting the circuit of left and right surround speakers.

4. The wireless transmission device of surround sound stereo system of claim 1, wherein said left and right surround signals outputted from said main stereo system are processed by said front high-pass filter and then enter into said front mixer, and said subwoofer signal outputted from said main stereo system is processed by said low-pass filter and then enters into said front mixer; said left and right surround signals separated by said rear distributor are recovered by said rear high-pass filter, and said subwoofer signal separated by said rear distributor is recovered by said rear low-pass filter.

5. The wireless transmission device of surround sound stereo system of claim 1, wherein said left and right surround signals separated by said rear distributor are recovered by rear high-pass filter and then outputted to said left and right surround speakers via an amplify circuit, and said subwoofer signal separated by said rear distributor is recovered by said rear low-pass filter, and then outputted to said subwoofer via an amplify circuit.

6. The wireless transmission device of surround sound stereo system of claim 4, wherein said front low-pass filter, front high-pass filter, front mixer, and radio frequency transmitting module are disposed in said main stereo system, and said power supply circuit is electrically connected in parallel to said main stereo system.

7. The wireless transmission device of surround sound stereo system of claim 4, wherein said distributor, radio receiving module, rear low-pass filter, rear high-pass filter, rear power supply circuit, and subwoofer are integrated in a housing.

8. The wireless transmission device of surround sound stereo system of claim 4, wherein said distributor, radio frequency receiving module, rear low-pass filter, rear high-pass filter, rear power supply circuit, and subwoofer are integrated in a housing;
and said left and right surround signals separated by said rear distributor are recovered by said rear high-pass filter and then outputted to said left and right surround speakers via an amplify circuit, and said subwoofer signal separated by said rear distributor is recovered by said rear low-pass filter, and then outputted to said subwoofer via an amplify circuit; and each amplify circuit and said subwoofer are integrated in the same housing.

9. The wireless transmission device of surround sound stereo system of claim 4, wherein said front low-pass filter, front high-pass filter, front mixer, radio frequency transmitting module, and front power supply circuit are integrated in a housing, and have a port for electrically connecting to said main stereo system.

10. The wireless transmission device of surround sound stereo system of claim 4, wherein said rear distributor, radio frequency receiving module, rear low-pass filter, rear high-pass filter, and rear power supply circuit are integrated in a housing; said left and right surround signals separated by said rear distributor are recovered by said rear high-pass filter and outputted to said left and right surround speakers via an amplify circuit; and said subwoofer signal separated by said rear distributor is recovered by said rear low-pass filter, and then outputted to said subwoofer via an amplify circuit; and each amplify circuit and said subwoofer are integrated in the same housing, and have a port for electrically connecting the circuit of each speaker.

11. The wireless transmission device of surround sound stereo system of claim 4, wherein said front low-pass filter, front high-pass filter, and front mixer are disposed in said main stereo system, and driven to operate by the power supply circuit of said main stereo system; said radio frequency module is disposed in a housing and has a connector for connecting the signal and power supply of said main stereo system.

12. The wireless transmission device of surround sound stereo system of claim 4, wherein said subwoofer signal is mixed in said left surround signal.

13. The wireless transmission device of surround sound stereo system of claim 4, wherein said subwoofer signal is mixed in said right surround signal.

14. The wireless transmission device of surround sound stereo system of claim 4, wherein said subwoofer signal is mixed in said left and right surround sounds.
